(19) United States
(12) Patent Application Publication
(10) Pub. No.: US 2007/0006038 A1
(43) Pub. Date: Jan. 4, 2007

(54) Methods and apparatus using a hierarchical test development tree to specify devices and their test setups

(76) Inventor: Zhengrong Zhou, Santa Rosa, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/170,374

(22) Filed: Jun. 29, 2005

(51) Int. Cl. G06F 11/00

(52) U.S. Cl. 714/38

(57) ABSTRACT

In one embodiment, a computer program is provided with code to display a hierarchical test development tree within a GUI of an automated test development environment. The tree has a node to which device branches corresponding to DUTs are added. The computer program is also provided with code to automatically associate a pin configuration branch and a test setups branch with each device branch; and code to, in response to user interaction with branches of the tree, display a number of windows for specifying the DUTs and their test setups. Other embodiments are also disclosed.

### BACKGROUND

Prior to the manufacture and/or distribution of an electrical device (including a system or component such as a circuit board, integrated circuit, or system-on-a-chip (SOC)), the device is typically tested to determine whether it is built or functions as designed. Often, this testing is performed by automated test equipment (ATE, also called “testers”).

Prior to using ATE to test a device, a test developer must develop the series of tests that the ATE will execute while testing the device. Historically, this has been done on a custom basis for each device that ATE is to test. While a test developer has a great deal of latitude when developing custom tests, this is a costly and time-intensive process that can add a significant amount of delay to a device's “time to market” cycle.

In some cases, test development may be aided by test templates that specify default parameters and hardware resources for conducting a test. Such is the case with the SmartTest Program Generator software that provides test development capabilities for the Agilent 93000 SOC Series tester (both of which are distributed by Agilent Technologies, Inc. of Palo Alto, Calif., USA).

### SUMMARY OF THE INVENTION

In one embodiment, a computer program comprises code to display a hierarchical test development tree within a graphical user interface (GUI) of an automated test development environment. The tree comprises a node to which device branches corresponding to devices under test (DUTs) are added. The computer program also comprises code to automatically associate a pin configuration branch and a test setups branch with each device branch; and code to, in response to user interaction with branches of the tree, display a number of windows for specifying the DUTs and their test setups.

In another embodiment, a computer program comprises code to display a GUI of an automated test development environment; code to display a number of collapsible windows within the GUI; code to display a hierarchical test development tree within the GUI, in response to user selection of one of the icons; and code to, in response to user interaction with branches of the tree, display a number of windows for specifying the devices and their test setups. The collapsible windows contain icons for accessing automated test development tools. The tree comprises a node to which device branches corresponding to DUTs are added.

In yet another embodiment, a method for developing tests for automated test equipment comprises initiating a predetermined interaction with a hierarchical test development tree displayed within a GUI of an automated test development environment. The tree provides access to DUTs and their test setups. Upon initiating the predetermined interaction, input is provided to a number of displayed windows to specify a test setup for one of the DUTs.

Other embodiments are also disclosed.

### BRIEF DESCRIPTION OF THE DRAWINGS

Illustrative embodiments of the invention are illustrated in the drawings, in which:

FIGS. 1 & 9 illustrate computer-implemented methods for specifying devices and their test setups; and

FIGS. 2-8 illustrate various states of a graphical user interface for implementing the methods shown in FIGS. 1 & 9.

### DETAILED DESCRIPTION

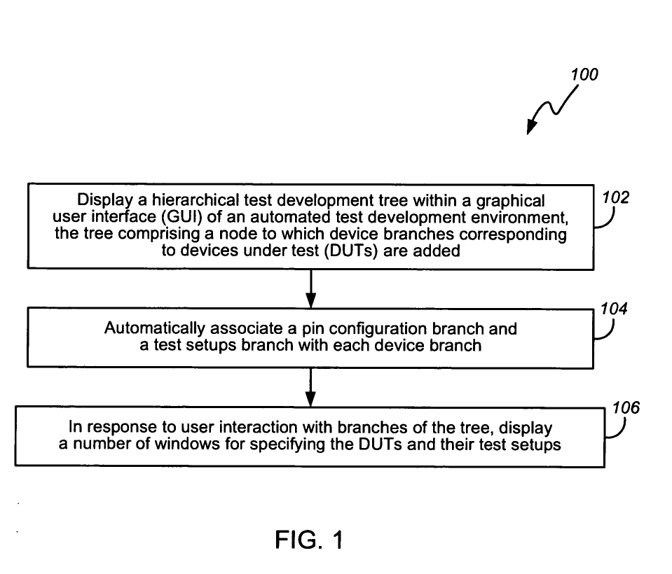

FIGS. 1 and 9 illustrate exemplary computer-implemented methods 100, 900 for specifying devices and their test setups. The methods 100, 900 may be used individually or in combination.

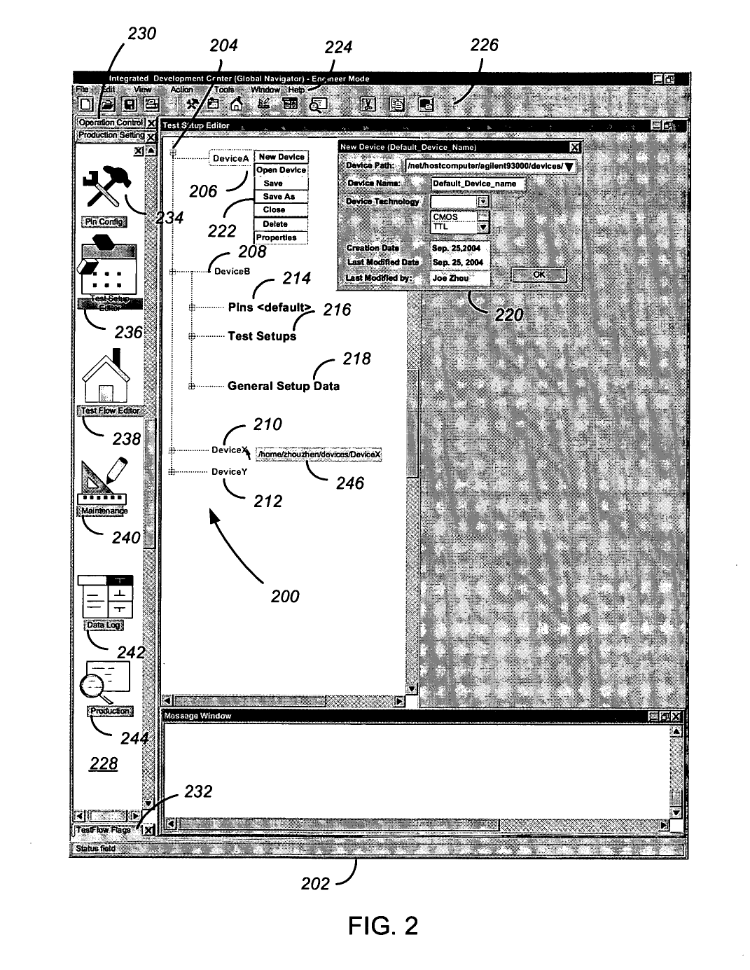

The method 100 (FIG. 1) comprises displaying 102 a hierarchical test development tree 200 (FIG. 2) within a graphical user interface (GUI 202) of an automated test development environment. As shown in FIG. 2, the tree 200 comprises one or more nodes 204 to which device branches 206, 208, 210, 212 (i.e., branches corresponding to devices under test (DUTs)) are added. A pin configuration branch and a test setups branch are automatically associated 104 with each of the device branches 206-212. See, for example, the pin configuration branch 214 and test setups branch 216 that are displayed in FIG. 2 as a result of expanding the device branch 208. In response to user interaction with the branches 206-218 of the tree 200, including the device branches 206-212, a number of windows (e.g., window 220) are displayed 106 for specifying DUTs and their test setups.

In one embodiment, the method 100 is embodied in sequences of instructions (i.e., a computer program) stored on a number of machine-readable media (e.g., one or more fixed or removable memories or disks). When executed by a machine (e.g., a computer or computer network), the sequences of instructions then cause the machine to perform the actions 102-106 of the method 100.

FIGS. 2-8 illustrate various exemplary states that an exemplary GUI 202 may take as a result of executing the method 100 (or executing sequences of instructions in which the method 100 and various extensions thereof are embodied).

As shown in FIG. 2, a menu 222 (such as a dropdown menu) may be displayed upon a predetermined interaction with the tree 200. In one embodiment, the predetermined interaction is a mouse-click on a device branch 206 of the tree 200. The menu 222 may provide access to various options for specifying a DUT, such as: a “New Device” option for creating a new device; an “Open Device” option for opening a device specification and making a reference to the device (e.g., a device branch) visible within the tree 200; “Save” and “Save As” options for saving a device's specification; a “Close” option for closing a device specification and hiding a reference to the device (e.g., hiding a device branch) from the tree 200; a “Delete” option to delete a device specification from the automated test development system that displays the GUI 202; and a “Properties” option to display properties of the branch's device. Access to these options may also be provided via the menu bar 224 or toolbar 226 of the GUI 202.

FIG. 2 not only shows an expansion of the menu 222, but also user selection of the device creation option (i.e., the “New Device” option) from within the menu 222. As shown, selection of the “New Device” option results in the display of an interface 220 (e.g., a window) for specifying various details of a DUT. In one embodiment, the details comprise a path (“Device Path”), name (“Device Name”) and technology (“Device Technology”) of a DUT. By way of example, a device's technology may be CMOS or TTL. The interface 220 may further provide log information, such as the date (“Creation Date”) on which a device was first created, the date (“Last Modified Date”) a device was last modified, and information (“Last Modified by”) on the last person to modify the device.

FIG. 2 further shows how a hover interaction with a device branch 210 (e.g., a mouse pointer hover) may result in the display of a device path 246 for the DUT associated with the device branch 210.

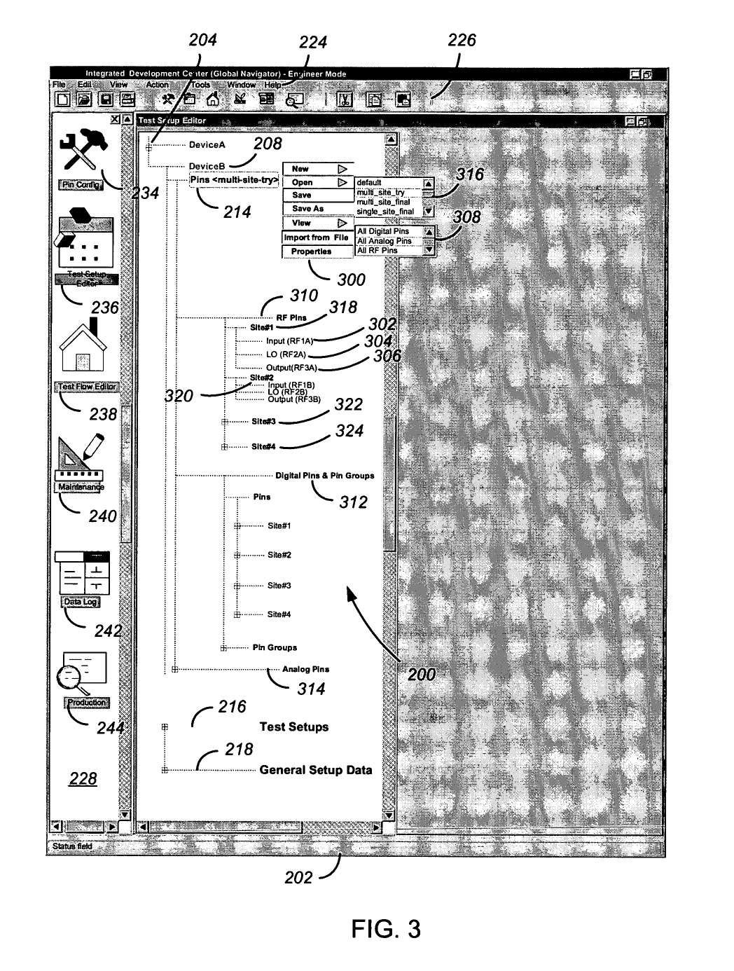

As shown in FIG. 3, a menu 300 (such as a dropdown menu) may be displayed upon a predetermined interaction with a pin configuration branch 214 of the tree 200. In one embodiment, the predetermined interaction is a mouse-click on a pin configuration branch 214 of the tree 200. The menu 300 may provide access to various options for configuring a pin or pins of a DUT, such as: a “New” option for adding a new pin group (or set); an “Open” option for opening a pin set for single or multi-site test; “Save” and “Save As” options for saving a pin's configuration; a “View” option for specifying which groups of pins should be displayed or hidden within a selected pin set; an “Import from File” option to import a pin's configuration from a saved file (such as an ascii file of a predetermined syntax); and a “Properties” option to display properties of a pin's configuration. Access to these options may also be provided via the menu bar 224 or toolbars 226, 228 of the GUI 202. In one embodiment, the syntax of the importable ascii file is as follows:

| ## | Pin Name | Pin Number | Pin Type | — |
|---|---|---|---|---|
| | in1 | 10101 | 1 | — |
| | reg1 | 30101 | io | — |

FIG. 3 not only shows an expansion of the menu 300, but also user selection of the “View” option from within the menu 300. As shown, selection of the “View” option may result in the display of a secondary menu 308 for choosing which pin groups are displayed in the tree 200, such as “All Digital Pins”, “All Analog Pins” or “All RF Pins”. Branches 310, 312, 314 corresponding to these pin groups may be displayed in the tree 200, with specific pin branches 302, 304, 306 being organized under the pin group branches 310-314.

Preferably, the tree 200 provides a means for directly displaying multi-site test information within the tree 200. In one embodiment, a single or multi-site pin set is opened by selecting the “Open” option from the menu 300. Selection of the “Open” option results in the display of a secondary menu 316 from which a user may select, for example, a “default”, “multi_site try”, “multi_site_final” or “single_site_final” pin set. As shown, the selection of a multi-site pin set may result in the display of site information (e.g., Site#1, Site#2, Site#3 and Site#4) in conjunction with each pin configuration branch 214, as branches 318, 320, 322, 324 of pin group branches 310-314. Pin branches 302-306 may then be organized under the site branches 318-324.

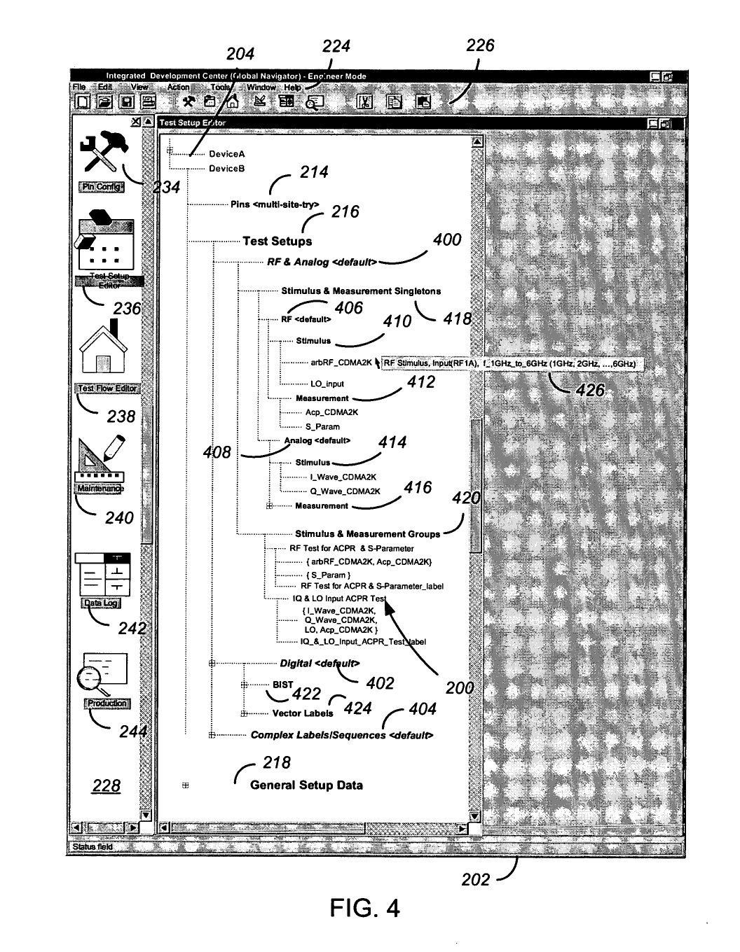

FIGS. 4-8 illustrate use of the GUI 202 to specify a DUT's test setups. As shown in FIG. 4, the tree 200 may be expanded to reveal various sub-branches of a DUT's test setups branch 216. As shown, the sub-branches may group the DUT's test setups under 1) an RF & Analog test setups branch 400, and 2) a digital test setups branch 402. Under the RF & Analog test setups branch 400, an RF branch 406 and an analog branch 408 may be provided. Under each of these branches 406, 408, stimulus and measurement sub-branches 410, 412, 414, 416 may be provided. Test setups are then preferably organized under the stimulus and measurement sub-branches 410-416.

In one embodiment, a device's RF & Analog test setups are further grouped under stimulus singleton, measurement singleton, and stimulus and measurement group sub-branches 418, 410-416, 420. The stimulus and measurement groups 420 serve to combine a number of RF and analog singletons.

It may also be useful to group a device's digital test setups 402 under digital built-in self-test (BIST) and vector label sub-branches 422, 424. A complex test setups branch 404 may also be provided. In one embodiment, complex test setups combine vector labels with analog or RF test setups.

Upon a hover interaction with one of the sub-branches, a summary 426 of the corresponding test setup may be displayed.

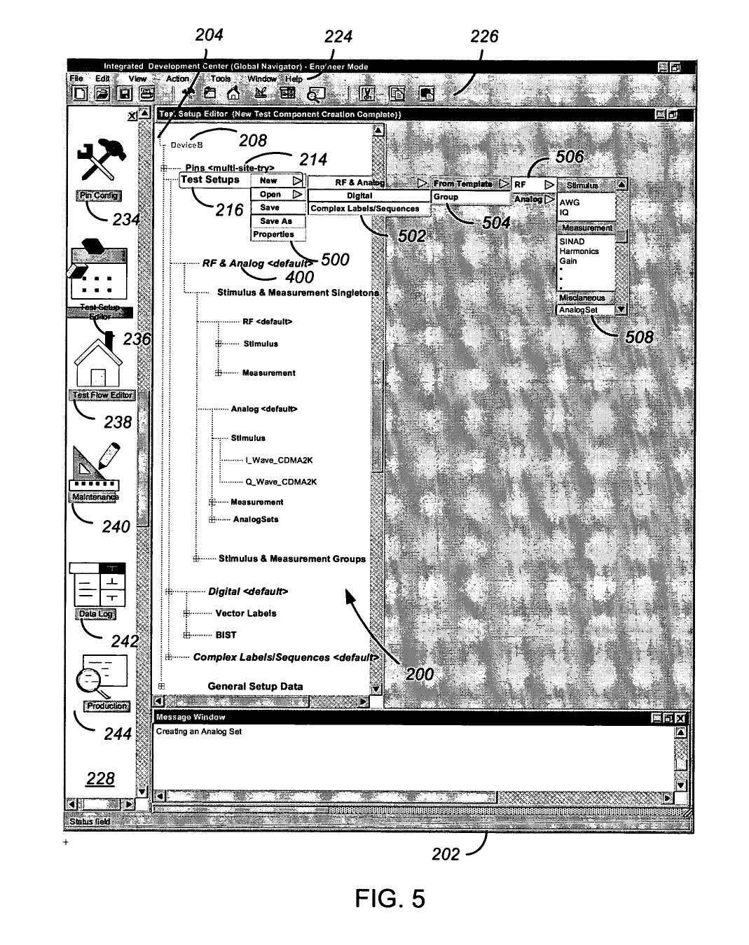

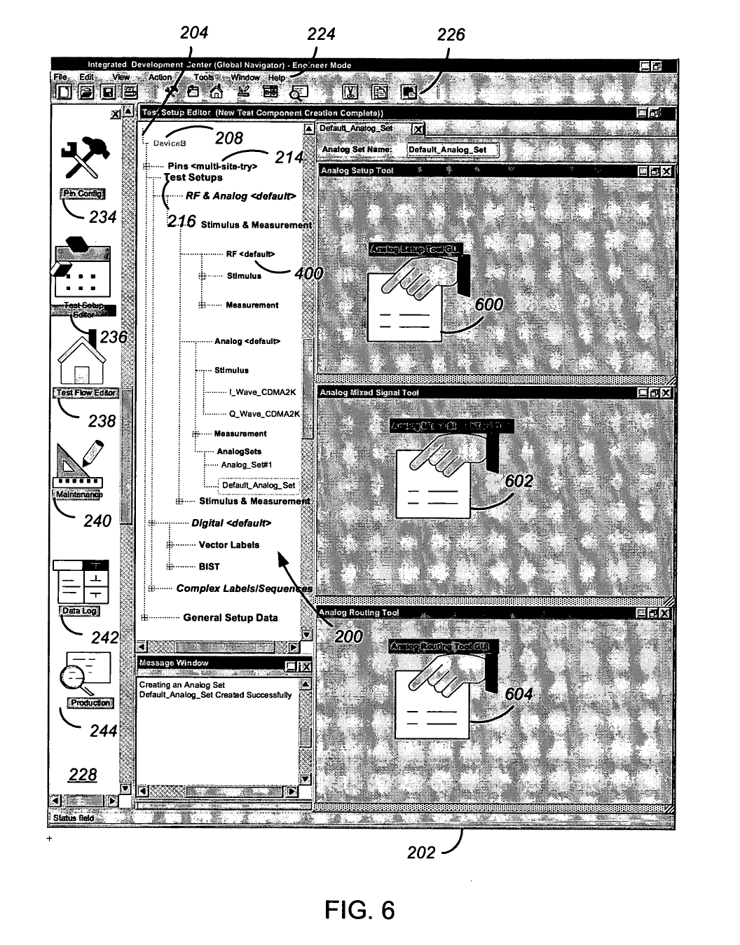

Upon a predetermined interaction (or interactions) with a test setups branch 216, 400-424, options for developing new test setups may be displayed, as shown in FIGS. 5-8. FIG. 5 illustrates the display of a series of menus as a result of clicking on the test setups branch 216 and then traversing a series of hierarchical menus 500, 502, 504, 506, 508. Note that a set of menus containing at least parts of the menus 500-508 could alternately be triggered by means of user interaction with other branches, such as the RF test setups branch 406, the analog test setups branch 408, or the digital test setups branch 402. Menu 504 illustrates options for specifying a test setup using a template. The specification of test setups using test templates is described more fully in the United States Patent Application of Zhou, et al. entitled “Method and Apparatus that Provide for Configuration of Hardware Resources Specified in a Test Template”, which was filed on the same date as this application under attorney docket number 10050009-1, and which is hereby incorporated by reference. Exemplary types of analog test setup templates are shown in menu 508. Upon selection of the AnalogSet template, various test setup tools may be launched, such as the Analog Setup Tool 600, Analog Mixed Signal Tool 602 and Analog Routing Tool 604 shown in FIG. 6. A discussion of the various test setup options that might be specified using these or other tools is beyond the scope of this description. However, preferably, a test setup template specifies default parameters and hardware resources that are sufficient to -define an executable test. That is, execution of a stimulus test should bring a stimulus signal to at least one ATE pin, and execution of a measurement test should record a measurement for at least one ATE pin. In this manner, a user need not do anything but select a test setup template to configure a device test.

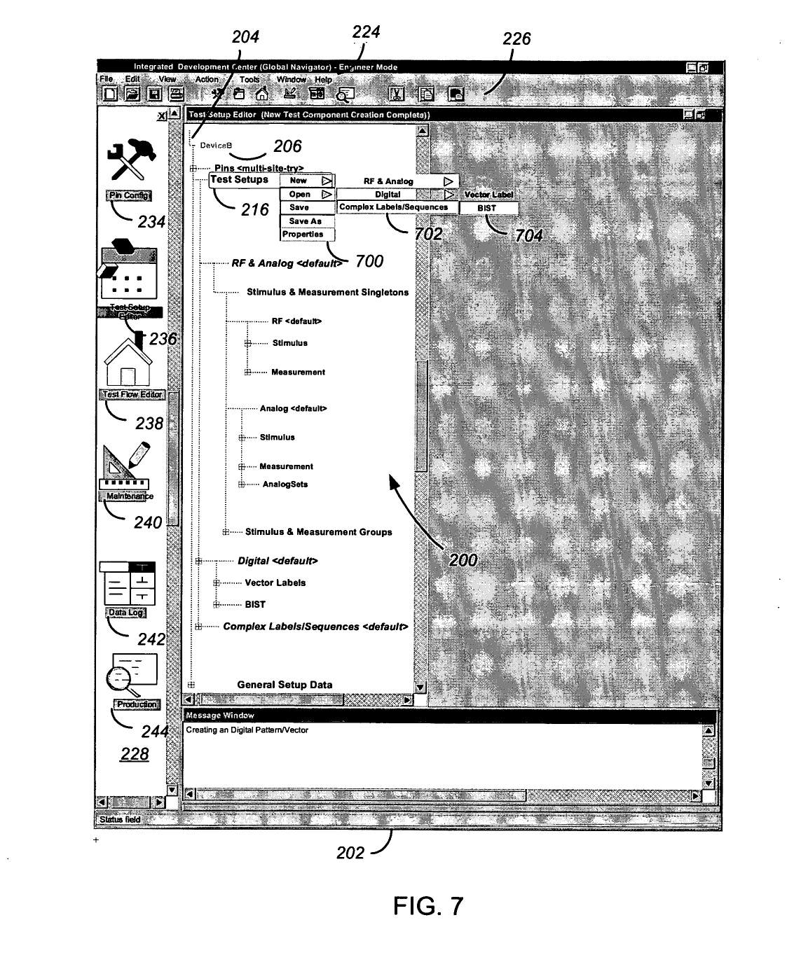

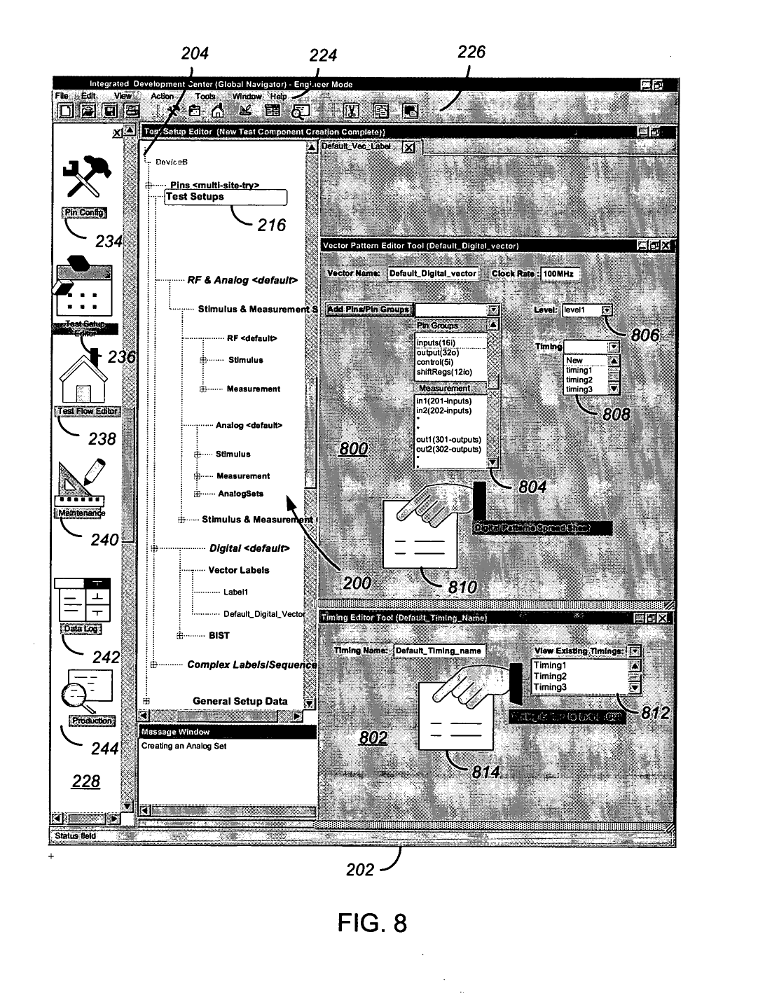

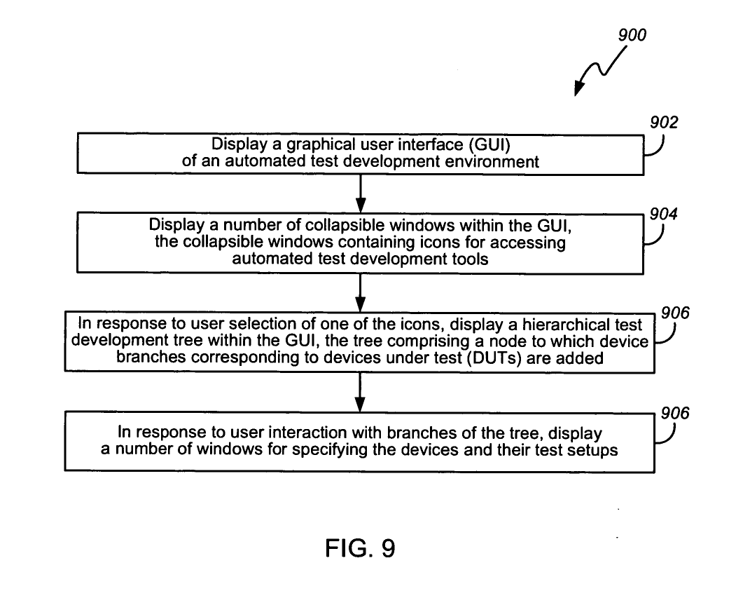

FIG. 7 illustrates the display of another series of menus that may be displayed as a result of clicking on the test setups branch 216 and then traversing a series of hierarchical menus 700, 702, 704. Note that the set of menus 700-704 could also be triggered by means of user interaction with the digital test setups branch 402. The series of menus 700-704 illustrates how the creation of a new vector label might be selected using the tree 200. Upon selection of the “Vector Label” option from the menu 704, the Vector Pattern Editor Tool (or window) 800 shown in FIG. 8 may be launched.

Using the tool 800, a user may select from existing pin groups 804 and then edit digital patterns associated with the pins using the Digital Patterns Spread Sheet 810. The user may also specify a level set 806 or pattern timing 808. If the user desires to specify pattern timing in more detail (e.g., a new or custom timing), the user may select “New” from within the timing window 808, thereby launching the Timing Editor Tool (or window) 802. Using the tool 802, the user may view an existing timing 812 in more detail, or the user may create a new timing 814. Although not shown in FIG. 8, the level set 806 can be handled (e.g. created or modified, etc.) in a similar manner via a tool that handles level sets, such as a “Level Editor Tool”. Upon creating a new vector label, it will be displayed under the vector label branch 424 of the tree 200.

Other tools for specifying test setups may be launched similarly to the tools 600-604, 800, 802 shown in FIGS. 6 & 8. Preferably, all test setups of a DUT are accessible via the tree 200.

FIG. 9 illustrates a second method 900 for specifying devices and their test setups. As previously indicated, the method 900 may be used in combination with the method 100. For example, as will become clear, the method 900 may be used as a means to launch the method 100.

The method 900 comprises displaying 902 a graphical user interface (GUI 202; FIG. 2) of an automated test development environment. Within the GUI 202 are displayed 904 a number of collapsible windows 228, 230, 232, at least some of which contain icons 234, 236, 238, 240, 242, 244 for accessing automated test development tools. A hierarchical test development tree 200 is also displayed within the GUI 202. The tree comprises a node 204 to which device branches 206-212 are added. In response to user interaction with the branches 206-218 of the tree 200, including the device branches 206-212, a number of interfaces 220, 600-604 (FIG. 6), 800, 802 (FIG. 8) may be displayed for specifying the DUTs and their test setups.

FIG. 2 illustrates an exemplary embodiment of the GUI 202 displayed by the method 900. By way of example, the GUI 202 comprises collapsible windows labeled “Operation Control” 230, “Production Settings” 228, and “TestFlow Flags” 232. In the GUI state shown, the window 228 labeled “Production Settings” is in its expanded (or open) form, while the windows 230, 232 labeled “Operation Control” and “TestFlow Flags” are shown collapsed. In one embodiment, the “Operation Control” window 230 comprises tools for controlling different levels of accessibility of the other tools (such as the test setup tools described above). For example, the “Operation Control” window 230 could provide access to “Operator” and “Developer” control modes, where general test setup tools are only accessible in the “Developer” mode and not in the “Operator” mode. The “TestFlow Flags” window 232 may comprise tools for controlling/manipulating test control flags. For example, there can be test control flags that enable or disable how many sites should be tested concurrently, or test execution flags that controls: how to log data; how much data to log; et cetera. The windows 230, 232 will not be discussed further, as the primary focus of this Description is the “Production Settings” window 228 (discussed in detail before and after this paragraph).

As shown in FIG. 2, the “Production Settings” window 228 may contain icons 234-244 for accessing automated test development tools such as a pin configuration tool 234, a test setup editor 236, and a testflow editor 238. In one embodiment, the selection of any of these tools 234-238 triggers the display of the tree 200.

The methods 100, 900 and apparatus 202 disclosed herein are useful in one respect in that they provide an efficient means for users to -specify devices and their test setups. Many test development environments do not provide any guidance as to where a user should start, and various test development tools are launched from different sources without there being any indication of the hierarchical nature in which devices and their test setups are related. The integrated nature of the methods 100, 900 and apparatus 202 disclosed herein, with their reliance on a hierarchical test development tree 200, tend to make them more efficient than past tools, thereby improving their time-to-market for tested devices.

What is claimed is:

1. A computer program, comprising:
code to display a hierarchical test development tree within a graphical user interface (GUI) of an automated test development environment, the tree comprising a node to which device branches corresponding to devices under test (DUTs) are added;
code to automatically associate a pin configuration branch and a test setups branch with each device branch; and
code to, in response to user interaction with branches of the tree, display a number of windows for specifying the DUTs and their test setups.

2. The computer program of claim 1, wherein all test setups of the DUTs are accessible via the tree.

3. The computer program of claim 1, further comprising:
code to, upon a predetermined interaction with the tree, display a dropdown menu providing access to a device creation option.

4. The computer program of claim 3, further comprising:
code to, upon user selection of the device creation option, display an interface for specifying a path, name and technology of a DUT.

5. The computer program of claim 1, further comprising:
code to, upon a predetermined interaction with a device branch, display a dropdown menu providing access to i) an option for hiding the device branch, and ii) a device properties option.

6. The computer program of claim 5, wherein the predetermined interaction is a mouse-click.

7. The computer program of claim 1, further comprising:
code to, upon a hover interaction with a device branch, display a device path for the DUT associated with the device branch.

8. The computer program of claim 1, further comprising:
code to, upon a predetermined interaction with a pin configuration branch, display a dropdown menu providing access to a pin configuration import option.

9. The computer program of claim 8, wherein the predetermined interaction is a mouse-click.

10. The computer program of claim 1, wherein multi-site pin information is directly displayed in the tree, in conjunction with each pin configuration branch.

11. The computer program of claim 1, further comprising:
code to, upon a predetermined interaction with a pin configuration branch, display a dropdown menu providing access to pin group viewing options.

12. The computer program of claim 11, wherein the pin group viewing options provide for viewing all analog pins, all RF pins, and all digital pins.

13. The computer program of claim 1, further comprising:
code to, upon a predetermined interaction with a test setups branch, display options for developing new test setups.

14. The computer program of claim 13, wherein the options for developing new test setups comprise options for developing analog, RF and digital test setups.

15. The computer program of claim 13, wherein the options for developing new test setups comprise an option for developing a vector label, the computer program further comprising:
code to, upon selection of the option for developing a vector label, display a vector pattern editor window for specifying the vector label, including a default or custom pattern timing; and
code to, upon selection of a custom pattern timing, display a timing editor window.

16. The computer program of claim 1, wherein the test setups branch of a device comprises sub-branches corresponding to the device's test setups, the computer program further comprising:
code to, upon a hover interaction with one of the sub-branches, display a summary of the corresponding test setup.

17. The computer program of claim 1, further comprising:
code to group a device's test setups under sub-branches of the device's test setups branch, the sub-branches comprising i) an RF & Analog test setups branch, and ii) a digital test setups branch.

18. The computer program of claim 17, further comprising:
code to group a device's RF & Analog test setups under stimulus and measurement sub-branches.

19. The computer program of claim 17, further comprising:
code to group a device's RF & Analog test setups under stimulus singleton, measurement singleton, and stimulus and measurement group sub-branches.

20. The computer program of claim 17, further comprising:
code to group a device's digital test setups under digital built-in self-test (BIST) and digital test pattern sub-branches.

21. The computer program of claim 17, wherein the sub-branches further comprise a complex test setups branch, wherein complex test setups combine digital test patterns with analog or RF test setups.

22. A computer program, comprising:
code to display a graphical user interface (GUI) of an automated test development environment;
code to display a number of collapsible windows within the GUI, the collapsible windows containing icons for accessing automated test development tools;
code to, in response to user selection of one of the icons, display a hierarchical test development tree within the GUI, the tree comprising a node to which device branches corresponding to devices under test (DUTs) are added; and
code to, in response to user interaction with branches of the tree, display a number of windows for specifying the devices and their test setups.

23. The computer program of claim 22, wherein the automated test development tools comprise a pin configuration tool, a test setup editor, and a testflow editor.

24. The computer program of claim 22, wherein all test setups of the DUTs are accessible via the tree.

25. The computer program of claim 22, further comprising:
code to display a test setups branch corresponding to each device branch;
code to, upon a predetermined interaction with a test setups branch, display options for specifying new analog & RF test setups; and
code to, upon selection of one of the options for developing new analog & RF test setups, display a number of interface windows for specifying the selected new test setup.

26. The computer program of claim 22, further comprising:
code to display a test setups branch corresponding to each device branch;
code to, upon a predetermined interaction with a test setups branch, display an option for specifying a vector label;
code to, upon selection of the option for specifying the vector label, display a digital pattern editor window for specifying the vector label, including a default or custom pattern timing; and
code to, upon selection of a custom pattern timing, display a timing editor window.

27. A method for developing tests for automated test equipment, comprising:
initiating a predetermined interaction with a hierarchical test development tree displayed within a graphical user interface (GUI) of an automated test development environment, the tree providing access to devices under test (DUTs) and DUT test setups; and
upon initiating the predetermined interaction, providing input to a number of displayed windows to specify a test setup for one of the DUTs.
